(19) United States
(12) Patent Application Publication
(10) Pub. No.: US 2009/0025438 A1
(43) Pub. Date: Jan. 29, 2009

(54) LOCKSET HAVING AN ELECTRICALLY OPERATED CLUTCH TO CONTROL TRANSMISSION OF ROTATION FROM AN OUTSIDE HANDLE TO AN OUTSIDE SPINDLE

(76) Inventors: Lan-Kun DON, Chiayi City (TW); Chen-Ming LIN, Chiayi County (TW)

Correspondence Address: LADAS & PARRY LLP, 224 SOUTH MICHIGAN AVENUE, SUITE 1600, CHICAGO, IL, 60604, US

(21) Appl. No.: 12/179,001

(22) Filed: Jul. 24, 2008

(30) Foreign Application Priority Data
Jul. 27, 2007 (TW) 096212464

(51) Int. Cl. E05B 13/10

(52) U.S. Cl. 70/224; 70/277

(57) ABSTRACT

A lockset includes an electric actuator which is disposed within an inside drive assembly and which has an actuator rod extending axially and movably into an outside drive assembly. The outside drive assembly has an outside sleeve connected to an outside handle and receiving an outside spindle. The outside sleeve has an axial cutout, whereas the outside spindle has an axial notch aligned with the cutout. A clutch element extends transversely from the actuator rod into the cutout and is movable within the cutout toward or away from a cutout bottom for sliding into or away from the notch so that the outside spindle and the outside sleeve are co-rotatable or not co-rotatable.

### CROSS-REFERENCE TO RELATED APPLICATION

This application claims priority of Taiwanese Utility Model Patent Application No. 096212464 filed on Jul. 27, 2007.

### BACKGROUND OF THE INVENTION

1. Field of the Invention

This application relates to a lockset mountable on a door, more particularly to a lockset having an electrically operated clutch to control transmission of rotation from an outside handle to an outside spindle that has an actuating part to actuate a latch retractor.

2. Description of the Related Art

It is known in the art to provide a door lockset with an electric actuator to actuate a clutch that can couple rotatably an outside spindle to an outside sleeve connected an outside handle. For example, U.S. Pat. No. 6,038,896 discloses a door lock that includes an electric motor mounted coaxially within an inside spindle and having a motor shaft (31) extending through a cylindrical lock chassis (80) to operably engage a member (40) for locking an outside spindle (50), and a mechanism (42, 45, 61) for selectively moving the member (40) between locked and unlocked positions.

It is also known in the art to provide a door lockset with a non-electrically operated clutch mechanism to couple rotatably an outside spindle to an outside tube that surrounds the outside spindle and that is connected to an outside handle. For example, U.S. Pat. No. 6,705,138 B1 discloses an outside spindle (42) received in an outside tube (41), a sleeve (43) received in the outside spindle (42), and a lug (44). A ring (441) of the lug (44) is pivotally mounted around an end of the sleeve (43), and an arm (442) of the lug (44) extends through a notch (422) in the outside spindle (42) and a slot (411) in the outside tube (41) and into a restraining recessed portion (332) of an outside hub (33). A push button (15) is connected to a locking bar (14) which has an end (142) securely engaged in a slot (432) of the sleeve (43). When the push button is pressed, the locking bar moves the lug which in turn moves the outside spindle 42 so that the arm of the lug extends into both of the slot (411) in the outside tube and the notch (422) in the outside spindle, thereby permitting the outside spindle and the outside tube to rotate jointly.

While various mechanically and electrically operated clutch mechanisms are provided in the art to control transmission of rotation from an outside handle to an outside spindle, improvements on those clutch mechanisms are still desirable to simplify construction and to reduce manufacturing costs.

### SUMMARY OF THE INVENTION

An object of the present invention is to provide a lockset with a simple clutch mechanism for controlling co-rotation of an outside spindle and an outside tube connected to an outside handle.

Accordingly, the present invention provides a lockset which comprises: inside and outside drive assemblies adapted to operate a latch retractor; and an electric actuator disposed within the inside drive assembly and including an actuator rod that extends axially and movably into the outside drive assembly and that has a clutch element. The outside drive assembly has an outside sleeve adapted to connect an outside handle, and an outside spindle disposed inside the outside sleeve and adapted to operate the latch retractor. The outside sleeve has a cutout that extends axially and that has a cutout bottom. The outside spindle has a tubular spindle wall surrounded by the outside sleeve, and a notch that extends axially in the spindle wall and that can be aligned with the cutout. The clutch element extends transversely from the actuator rod into the cutout, and is slidable axially in the cutout so as to move toward or away from the cutout bottom when the actuator rod moves axially. The clutch element moves into the notch and rotatably couples the outside sleeve to the outside spindle when moving toward the cutout bottom so that rotation of the outside sleeve can be transmitted to the outside spindle. The clutch element moves away from the notch and uncouples the outside sleeve and the outside spindle when moving away from the cutout bottom so that rotation of the outside sleeve cannot be transmitted to the outside spindle.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is an exploded view of a lockset embodying the present invention;

FIG. 2 is an exploded view of a drive mechanism of the lockset;

FIG. 3 is a perspective view of an assembly of outside spindle and outside tube;

FIG. 4 is a perspective view of an electric actuator;

FIG. 5 is a perspective view showing that a clutch element extends into the outside spindle and outside tube;

FIG. 6 is the same view as FIG. 5, but showing the clutch element moving into a notch of the outside spindle; and

FIG. 7 is a perspective view showing the clutch element sliding within a recess of the outside spindle.

### DETAILED DESCRIPTION OF THE PREFERRED EMBODIMENTS

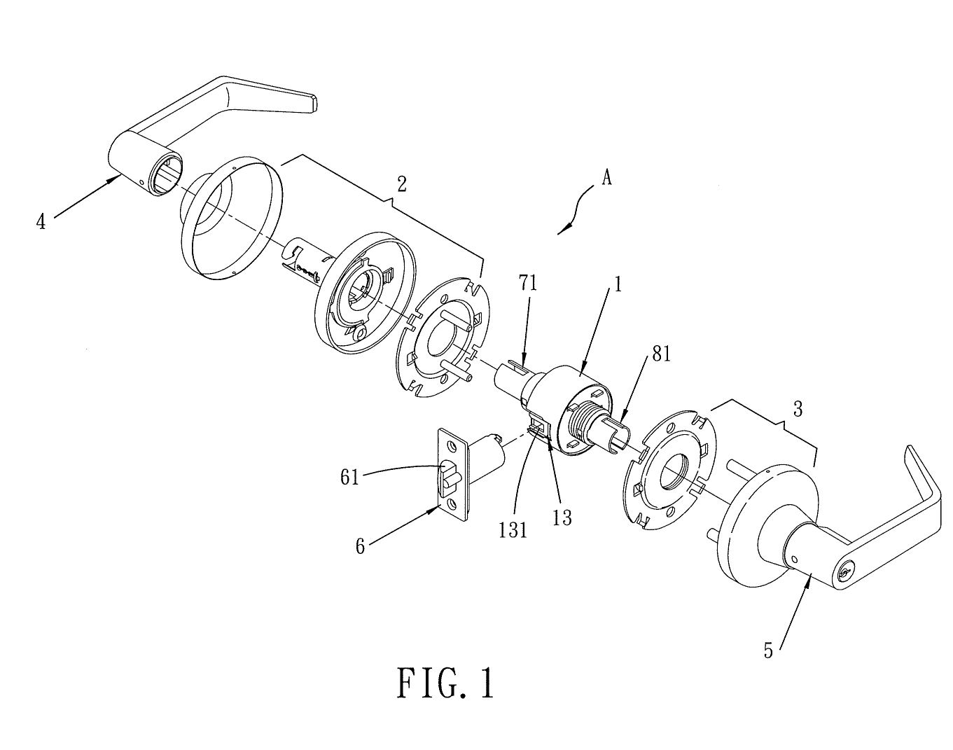

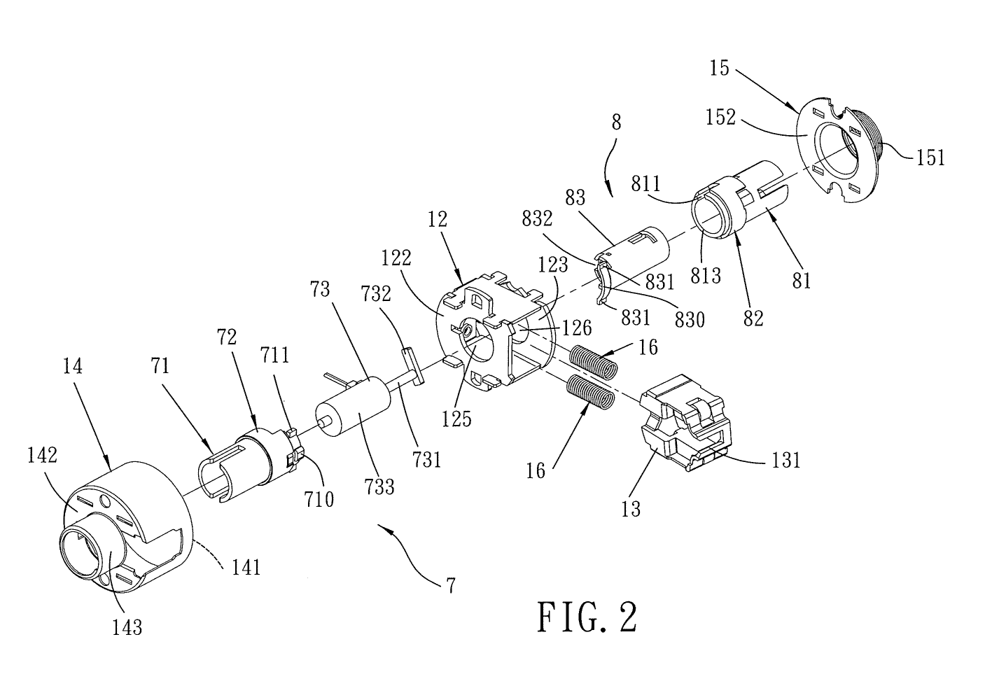

Referring to FIGS. 1 and 2, a lockset (A) embodying the present invention includes inside and outside rose assemblies 2 and 3 connected respectively to inside and outside handles 4 and 5 which are used to operate a drive mechanism 1. The drive mechanism 1 includes a retractor cage 12, inside and outside cases 14, 15, a latch retractor 13, springs 16, inside and outside drive assemblies 7, 8, and a latch unit 6 having a latch bolt 61.

The retractor cage 12 encloses the latch retractor 13 and has inside and outside cover plates 122, 123 on two sides of the latch retractor 13. Passage holes 125, 126 are respectively provided in the inside and outside cover plates 122, 123. The latch retractor 13 is biased by the springs 16 and has a connection part 131 connected to the latch bolt 61. Since the constructions of the retractor cage 12 and the latch retractor 13 are known, the details thereof are omitted herein.

The inside case 14 is substantially cylindrical as is known in the art, and has one end provided with an end plate 142 and a constricted hollow neck 143 projecting from the end plate 142. The other end of the inside case 14 is provided with an opening 141. The end plate 142 is coupled to the inside cover plate 122 in a known fashion. The outside case 15 has a tubular part 151, and an annular flange 152 projecting from the tubular part 151. The annular flange 152 is fitted in the opening 141 and coupled to the outside cover plate 123 in a known manner.

The inside drive assembly 7 has an inside spindle 71, a ring 72 embracing the inside spindle 71, and an electric actuator 73 disposed within the inside spindle 71. The inside spindle 71 has a conventional structure and is connected to the inside handle 4 in a known manner. The inside spindle 71 has a retractor-actuating part 710 that extends into the retractor cage 12 through the passage hole 125 and that has tabs 711 to abut against the latch retractor 13.

The electric actuator 73 has a cylinder body 733 disposed inside the inside spindle 71, an actuator rod 731 extending axially and outwardly from the cylinder body 733, and a clutch element 732 projecting transversely from the actuator rod 731. The actuator rod 731 extends from the inside spindle 71 through the passage holes 125, 126 in the inside and outside cover plates 122, 123 and the latch retractor 13, and the clutch element 732 extends into the outside drive assembly 8. The actuator rod 731 is freely rotatable, and can move axially in one direction when the electric actuator 73 is energized and in an opposite direction when the electric actuator 73 is de-energized.

The outside drive assembly 8 includes an outside sleeve 81, an outside spindle 83 disposed inside the outside sleeve 81, and a ring 82 embracing the outside sleeve 81. The outside sleeve 81 is connected to the outside handle 5 in a known manner. The outside spindle 83 is disposed within the outside sleeve 81 and has a retractor-actuating part 830 that has tabs 831 projecting therefrom for operating the latch retractor 13. The outside spindle 83 is connected to a tail piece (not shown) of a key-operated lock (not shown) in a conventional manner.

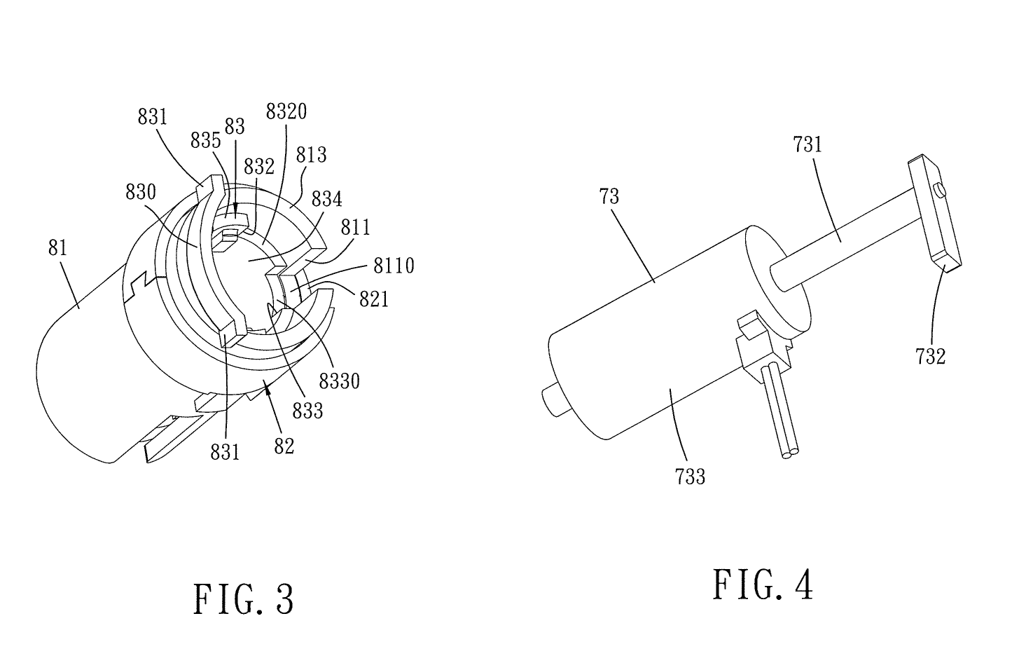

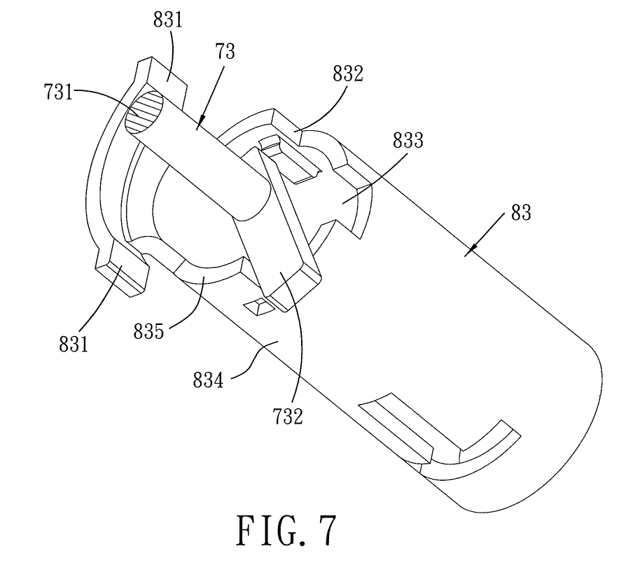

Referring to FIGS. 3-7, the outside sleeve 81 has an inside end 813 adjacent to the retractor cage 12. The inside end 813 is notched to form a cutout 811. The ring 82 is also notched to form another cutout 821 in alignment with the cutout 811. The outside spindle 83 has a tubular spindle wall 834 with an inside end 835 from which the retractor-actuating part 830 projects. The spindle wall 834 is formed with a recess 832 and a notch 833. The notch 833 is aligned with the cutout 811 in a locking state of the lockset (A), and has a notch bottom 8330 substantially flush with a cutout bottom 8110 of the cutout 811. The recess 832 is shallower and wider than the notch 833. The inside end 835 is notched to form the recess 832, whereas a recess bottom 8320 of the recess 832 is notched to form the notch 833. The notch 833 extends from the recess bottom 8320 to the notch bottom 8330 that is deeper than the recess bottom 8320. The notch 833 is substantially as wide as the cutout 811 in an angular direction.

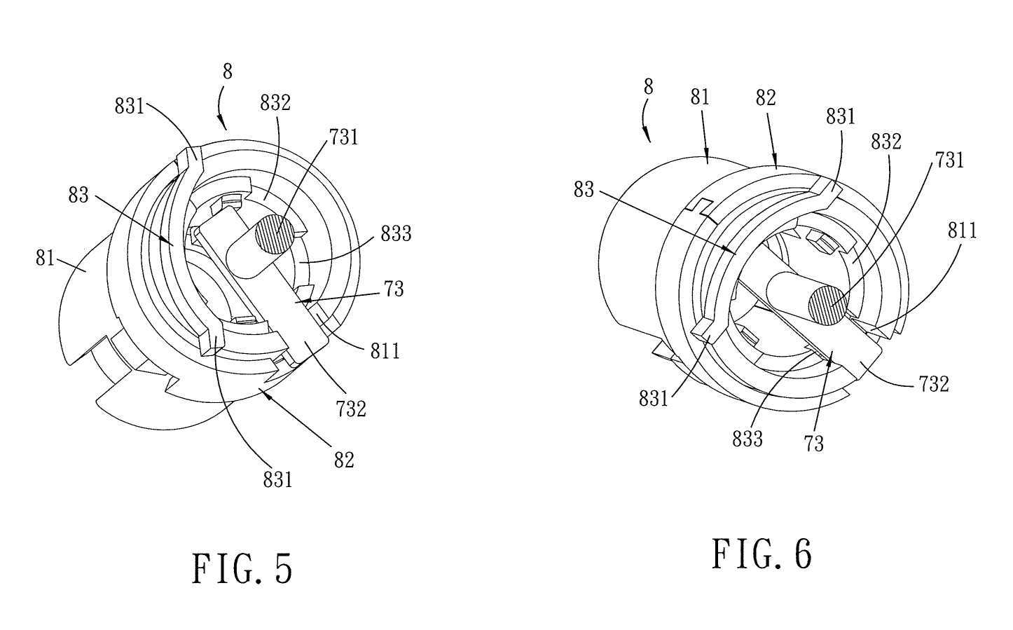

After assembly of the lockset (A), the actuator rod 731 extends axially and movably into the outside drive assembly 8. The clutch element 732 extends transversely from the actuator rod 731 into the cutout 811 and is slidable axially in the cutout 811. When the actuator rod 731 moves axially, the clutch element 732 moves toward or away from the cutout bottom 8110 without moving out of the cutout 811. The notch 833 is normally aligned with the cutout 811 when the outside handle 5 is not rotated. When the clutch element 732 moves toward the cutout bottom 8110, it moves into the notch 833 (see FIG. 6), thereby rotatably coupling the outside sleeve 81 and the outside spindle 83 and transmitting rotation of the outside sleeve 81 to the outside spindle 83 through the clutch element 732. When the clutch element 732 moves away from the cutout bottom 8110, it moves away from the notch 833, thereby uncoupling the outside sleeve 81 and the outside spindle 83 and preventing transmission of rotation of the outside sleeve 81 to the outside spindle 83. In this condition, the clutch element 732 is within the recess 832 and is rotatable along the recess bottom 8320 above the notch 833 as shown in FIG. 5.

Referring to FIG. 3 in combination with FIG. 2, the inside end 813 of the outside sleeve 81 is in contact with the outer side of the outside cover plate 123 of the retractor cage 12. The retractor-actuating part 830 projects outwardly of the inside end 813 of the outside sleeve 81 and extends into the retractor cage 12 through the passage hole 126. Since the tabs 831 project from the retractor-actuating part 830, they are not permitted to pass through the passage hole 126. Furthermore, because the tabs 831 cannot move out of the retractor cage 12 and because the tabs 831 abut against the latch retractor 13, the outside spindle 83 is limited from moving axially. Such an arrangement is conventional. Alternatively, limitation of the outside spindle 83 from axial movement may be accomplished by using any other suitable known arrangement.

Referring back to FIGS. 1, 2, 3, 5 and 6, the clutch element 732 extends into the cutout 811 either in a locking, or unlocking state of the lockset (A). However, when the lockset (A) is in a normal locking state, the clutch element 732 does not extend into the notch 833 but stays within the recess 832 (see FIG. 5). In this state, the electric actuator 73 is de-energized, the outside sleeve 81 will idle and slide along the recess bottom 8320 when the outside sleeve 81 is rotated through the outside handle 5, and rotation of the outside sleeve 81 cannot be transmitted to the outside spindle 83. As a result, the latch bolt 61 cannot be retracted.

When the electric actuator 73 is energized to place the lockset (A) in an unlocking state, the actuator rod 731 moves outward, i.e. in a direction toward the outside handle 5, so that the clutch element 732 moves toward the cutout bottom 8110 of the cutout 811. In this state, the clutch element 732 engages the notch 833 (see FIG. 6) so that the outside spindle 83 can be rotated through the rotation of the outside sleeve 81 to retract the latch bolt 61.

The lockset (A) may also be operated by rotating the inside spindle 71 through the inside handle 4 or by using a key to turn the outside spindle 83. Operations as such are known and are therefore omitted herein.

The electric actuator 73 may be any type of known solenoid actuator which has an actuator rod that can move in a direction toward the inside handle 4, or toward the outside handle 5 when the solenoid actuator is energized. In the preferred embodiment described hereinbefore, when the electric actuator 73 is energized, the actuator rod 731 moves toward the outside handle 5 so as to couple and co-rotate the outside sleeve 81 and the outside spindle 83. When the electric actuator 73 is de-energized, the outside handle 5 idles and does not permit a door to open.

Conversely, if the actuator rod 731 moves toward the inside handle 4 when the electric actuator 73 is in an energized state, the outside sleeve 81 and the outside spindle 83 cannot co-rotate in the energized state, and the outside handle 5 will idle. When the electric actuator 73 is de-energized, the actuator rod 731 moves toward the outside handle 5, and the outside sleeve 81 and the outside spindle 83 can co-rotate and permit the door to open when the outside handle 5 is turned.

While the present invention has been described in connection with what are considered the most practical and preferred embodiments, it is understood that this invention is not limited to the disclosed embodiment but is intended to cover various arrangements included within the spirit and scope of the broadest interpretations and equivalent arrangements.

We claim:

1. A lockset comprising:
inside and outside drive assemblies adapted to operate a latch retractor; and
an electric actuator disposed within said inside drive assembly and including an actuator rod that extends axially and movably into said outside drive assembly and that has a clutch element;
said outside drive assembly having an outside sleeve adapted to connect an outside handle, and an outside spindle disposed inside said outside sleeve and adapted to operate the latch retractor;
said outside sleeve having a cutout that extends axially and that has a cutout bottom;
said outside spindle having a tubular spindle wall surrounded by said outside sleeve, and a notch that extends axially in said spindle wall and that can be aligned with said cutout;
said clutch element extending transversely from said actuator rod into said cutout and being slidable axially in said cutout so as to move toward or away from said cutout bottom when said actuator rod moves axially;
said clutch element moving into said notch and rotatably coupling said outside sleeve to said outside spindle when moving toward said cutout bottom so that rotation of said outside sleeve can be transmitted to said outside spindle;
said clutch element moving away from said notch and uncoupling said outside sleeve and said outside spindle when moving away from said cutout bottom so that rotation of said outside sleeve cannot be transmitted to said outside spindle.

2. The lockset as claimed in claim 1, wherein said spindle wall has an inside end, and a retractor-actuating part projecting from said inside end, said notch being provided in said inside end and having a notch bottom, said spindle wall further having a recess in said inside end, said recess being shallower and wider than said notch and having a recess bottom, said inside end being notched to form said recess, said recess bottom being notched to form said notch, said notch extending from said recess bottom to said notch bottom, said clutch element being rotatable along said recess bottom when moving away from said notch.

3. The lockset as claimed in claim 2, wherein said notch bottom is substantially flush with said cutout bottom, and said notch is substantially as wide as said cutout in an angular direction.

4. A lockset comprising:
an electric actuator including an actuator rod that has a clutch element;
an outside sleeve having a cutout extending axially and having a cutout bottom; and
an outside spindle adapted to operate a latch retractor, and having a tubular spindle wall surrounded by said outside sleeve, and a notch that extends axially in said spindle wall and that is aligned with said cutout;
said actuator rod extending axially and movably to said outside sleeve and said outside spindle;
said clutch element extending transversely from said actuator rod into said cutout and being slidable axially in said cutout so as to move toward or away from said cutout bottom when said actuator rod moves axially;
said clutch element moving into said notch and rotatably coupling said outside sleeve to said outside spindle when moving toward said cutout bottom so that rotation of said outside sleeve can be transmitted to said outside spindle;
said clutch element moving away from said notch and uncoupling said outside sleeve and said outside spindle when moving away from said cutout bottom so that rotation of said outside sleeve cannot be transmitted to said outside spindle.

5. The lockset as claimed in claim 4, wherein said spindle wall has an inside end, and a retractor-actuating part projecting from said inside end, said notch being provided in said inside end and having a notch bottom, said spindle wall further having a recess in said inside end, said recess being shallower and wider than said notch and having a recess bottom, said inside end being notched to form said recess, said recess bottom being notched to form said notch, said notch extending from said recess bottom to said notch bottom, said clutch element being rotatable along said recess bottom when moving away from said notch.

6. The lockset as claimed in claim 5, wherein said notch bottom is substantially flush with said cutout bottom, and said notch is substantially as wide as said cutout in an angular direction.
